(19) United States
(12) Patent Application Publication
(10) Pub. No.: US 2015/0081554 A1
(43) Pub. Date: Mar. 19, 2015

(54) Systems and Methods for Managing Mobile Account Holder Verification Methods

(71) Applicants: Erick Wong, Menlo Park, CA (US); Kiushan Pirzadeh, Foster City, CA (US); Christian Aabye, Foster City, CA (US)

(72) Inventors: Erick Wong, Menlo Park, CA (US); Kiushan Pirzadeh, Foster City, CA (US); Christian Aabye, Foster City, CA (US)

(21) Appl. No.: 14/490,522

(22) Filed: Sep. 18, 2014

Related U.S. Application Data
(60) Provisional application No. 61/879,632, filed on Sep. 18, 2013.

(51) Int. Cl. G06Q 20/40; G06Q 20/36

(52) U.S. Cl. CPC G06Q 20/401; G06Q 40/02; G06Q 20/36
USPC 705/44; 705/35

(57) ABSTRACT

Embodiments of the invention are directed to methods, apparatuses, computer readable media and systems for coordinating account holder verification methods among secure entity applications and wallet applications from different issuers, wallet providers, etc. on mobile devices. A common payment management application may be provided in a trusted execution environment associated with a mobile device to support secure entity applications (e.g., provisioned payment application instances in the trusted execution environment) and mobile wallet applications (e.g., provisioned on a memory of the mobile device) to coordinate account holder verification methods. The common payment management application may be accessible by both mobile applications and the secure entity applications.

### CROSS-REFERENCES TO RELATED APPLICATIONS

This application claims benefit under 35 USC §119(e) to U.S. Provisional Patent Application No. 61/879,632 filed Sep. 18, 2013 and entitled “Systems and Methods for Managing Mobile Cardholder Verification Methods”, the disclosure of which is incorporated by reference herein in its entirety for all purposes.

### BACKGROUND

Typical payment network applications and digital wallets installed on a mobile communication device have pre-defined provider-specific means of supporting an account holder verification method on account holder devices during payments. Accordingly, account holders may be required to complete different account holder verification methods for each application or wallet installed on a mobile device.

For example, a standard payment account provisioned on a mobile phone requires a user sign-in to turn on the mobile phone, the wallet applet requires another passcode to authenticate the user, and when the user chooses to pay with a specific payment account, the payment network applet requires an issuer-specific passcode. The passcode could be the same or similar and the user may need to enter the passcode three separate times before being able to complete the payment request.

Embodiments of the present invention solve these problems and other problems, individually and collectively.

### BRIEF SUMMARY

Embodiments of the present invention coordinate and simplify account holder verification methods among secure entity applications and mobile wallet applications from different issuers, wallet providers, etc. on mobile devices.

Embodiments of the invention are directed to methods, apparatuses, computer readable media and systems for supporting secure entity applications (e.g., provisioned payment application instances in a trusted execution environment, such as a secure element, associated with the mobile device) and mobile wallet applications to coordinate account holder verification methods through the use of a common payment management application. The common payment management application is located in the trusted execution environment associated with the mobile device and is accessible by both mobile wallet applications and payment application instances (also referred to as secure entity applications, payment network applications, and payment applets).

One embodiment of the invention is directed to a method. The method includes receiving, at a management application located in a trusted execution environment associated with a mobile device, an account holder verification information. The method also includes receiving, at the management application, a first account holder verification request from a first application. A first account holder verification response is provided to the first application. The first account holder verification response is generated by the management application using the account holder verification information. The method further includes receiving, at the management application, a second account holder verification request from a second application. A second account holder verification response is provided to the second application. The second account holder verification response is generated by the management application using the account holder verification information.

Another exemplary embodiment of the invention is directed to a method. The method includes receiving, at a management application located in a trusted execution environment associated with a mobile device, an account holder verification result generated by a first application based on the first application verifying an identity of an account holder. The method also includes determining, by the management application, that the first application is configured to work with a second application to conduct a payment transaction. The first application and the second application are provided on one or more memory locations on the mobile device. Moreover, the method includes automatically providing, by the management application, the account holder verification result to the second application. The second application processes the payment transaction sing the account holder verification result.

An exemplary embodiment is directed to a system including a processor and a non-transitory computer readable medium coupled to the processor. The computer readable medium comprises code, that when executed by the processor, causes the processor to receive, at a management application located in a trusted execution environment associated with a mobile device, an account holder verification information. The code, when executed by the processor, further causes the processor to receive, at the management application, a first account holder verification request from a first application. The code, when executed by the processor, also causes the processor to provide a first account holder verification response to the first application. The first account holder verification response is generated by the management application using the account holder verification information. Moreover, the code, when executed by the processor, causes the processor to receive, at the management application, a second account holder verification request from a second application; and to provide a second account holder verification response to the second application. The second account holder verification response is generated by the management application using the account holder verification information.

Another exemplary embodiment is directed to a method. The method includes receiving, by a first application provided on a mobile device, a payment request for a transaction conducted with the mobile device. The method also includes sending, by the first application, an account holder verification request to a management application located in a trusted execution environment associated with the mobile device. The method further includes receiving, at the first application, an account holder verification response from the management application. The first account holder verification response is generated by the management application using account holder verification information provided to the management application by a user or a second application on the mobile device. Moreover, the method includes processing the payment request for the transaction based on the account holder verification response.

Another embodiment is directed to apparatuses, systems, and computer-readable media configured to perform the method described above.

These and other embodiments are described in further detail below.

### BRIEF DESCRIPTION OF THE DRAWINGS

FIG. 1A shows a block diagram of a user interacting with an exemplary mobile communication device, according to embodiments of the present invention.

FIG. 1B shows a flow diagram of a method for authenticating a user by a common payment management application and sharing the authentication results with applications provided on the mobile communication device, according to an exemplary embodiment of the present invention.

FIG. 2A shows a block diagram of a user interacting with an exemplary mobile application, according to embodiments of the present invention.

FIG. 2B shows a flow diagram of a method for authenticating a user by a mobile application and sharing the authentication results with other applications through a common payment management application, according to an exemplary embodiment of the present invention.

FIG. 3A shows a block diagram of a user interacting with an exemplary mobile application that is configured to work with an exemplary secure entity application provided on a secure element of a mobile device, according to embodiments of the present invention.

FIG. 3B shows a flow diagram of a method for authenticating a user by a secure entity application and sharing the authentication results with other mobile applications through a common payment management application, according to an exemplary embodiment of the present invention.

FIG. 4 shows a block diagram of an exemplary mobile communication device, according to embodiments of the present invention.

### DETAILED DESCRIPTION

Embodiments are directed to methods and systems for supporting account holder verification methods coordination among secure entity applications and mobile applications through the use of a common payment management application.

The secure entity applications may include payment network applications, issuer-specific mobile payment applications, banking applications, merchant applications, etc. that are provided in a trusted execution environment associated with a mobile device. The secure entity applications may refer to an application controlled by an entity that issued a secure account to a user.

The mobile applications may include mobile wallets, merchant applications, etc. provided on a memory of the mobile device. The mobile applications may refer to an application that provides an interface to a user to conduct a purchase transaction without necessarily assigning a secure account to the user.

The common payment management application is located in the trusted execution environment associated with the mobile device and is accessible by both the mobile applications and the secure entity applications. The trusted execution environment may include, but is not limited to, a secure element provided on the mobile device or a secure environment provided on a cloud storage. The common payment management application may provide uniform application programming interfaces (APIs) to the various mobile wallets, secure entity applications, and account holder applications configured to operate on a mobile communication device in order to allow an application to communicate with the common payment management application for providing and/or verifying the results of an account holder verification method.

In some embodiments, the common payment management application may receive user input (e.g. a password, account number, card verification value, user biometrics, a pattern, etc.) and perform the account holder verification method. The results of the account holder verification method may be stored at the common payment management application and provided to the mobile application(s) and the secure entity application(s) upon request. In other embodiments, the user may provide the user input to a mobile application. The mobile application may perform the account holder verification method and send the results of the account holder verification method to common payment management application. Alternatively, the mobile application may forward the user input to the common payment management application, which may perform the account holder verification method. The common payment management application may share the account holder verification results with other mobile applications or secure entity applications. In yet other exemplary embodiments, the user may provide user input to a mobile application that is configured to work with one or more secure entity applications. The mobile application may directly send the user input to the one or more secure entity applications which may perform the account holder verification method. The one or more secure entity applications may send the results of the account holder verification method to the common payment management application. The common payment management application may share the account holder verification results with other secure entity applications or mobile applications.

The common payment management application may provide results of account holder verification methods to the mobile applications and the secure entity applications through any suitable method as described herein, including pushing results to and pulling results from the mobile applications and the secure entity applications. Accordingly, embodiments create a seamless user experience by allowing the common payment management application to verify the account holder once, and allowing multiple mobile applications or secure entity applications to use the results of the completed account holder verification method to complete a transaction. The account holder no longer has to perform separate account holder verification methods for each mobile application and/or secure entity application even if each mobile application or secure entity application uses a different account holder verification method. As discussed in greater detail below, the common payment management application is adapted to perform various types of account holder verification methods. Thus, any type of account holder verification method may be used in embodiments of the present invention.

Specifically, secure entity applications may define a provider-specific means of supporting an account holder verification method on account holder devices (e.g., Visa™ has a payWave based account holder verification method) for the purposes of enabling payment transactions (and other mobile transactions). To support mobile wallets that may work with a variety of secure entity applications, and to acknowledge that most mobile wallet providers have instituted their own means of wallet authentication, embodiments of the present invention provide a mechanism to support account holder verification method coordination among secure entity applications and mobile wallets. The coordination will help to create a seamless user experience in such mobile wallets while ensuring that potential payment network and payment account issuer business requirements determining whether an account holder verification method has been entered are satisfied.

Embodiments of the invention have several advantages. For example, embodiments provide a more efficient and pleasurable account holder experience because the common payment management application may require a user to complete one type of an account holder verification method (e.g., enter one passcode) in order to use any of the provisioned secure entity applications, mobile wallet applications, or any other payment related applications no matter the issuer, wallet provider, or other third party associated with the applications. Further, embodiments store verification results or information important to account holder verification method methods (e.g., passcodes) in a trusted execution environment so that the account holder verification method information is more secure than typical wallet applications installed on general purpose memory.

Before discussing specific embodiments and examples, some descriptions of terms used herein are provided below.

As used herein, a “mobile device” may comprise any electronic device that may be transported and operated by a user, which may also provide remote communication capabilities to a network. Examples of remote communication capabilities include using a mobile phone (wireless) network, wireless data network (e.g. 3G, 4G or similar networks), Wi-Fi, Wi-Max, or any other communication medium that may provide access to a network such as the Internet or a private network. Examples of mobile devices include mobile phones (e.g. cellular phones), PDAs, tablet computers, net books, laptop computers, personal music players, hand-held specialized readers, etc. A mobile device may comprise any suitable hardware and software for performing such functions, and may also include multiple devices or components (e.g. when a device has remote access to a network by tethering to another device—i.e. using the other device as a modem—both devices taken together may be considered a single mobile device). A mobile device may also comprise a verification token in the form of, for instance, a secured hardware or software component within the mobile device and/or one or more external components that may be coupled to the mobile device. A detailed description of an exemplary mobile device is provided below.

A “trusted execution environment” may be a secure environment on a computing device, a mobile device or a cloud storage for securely storing data. A trusted execution environment may be supported in software, hardware, firmware or a combination thereof. The trusted execution environment may be implemented so that its execution and data space are isolated from other environments executing code on the computing device, the mobile device or the cloud. For example, the trusted execution environment may have dedicated or protected processing and system resources, such as secure storage and protected memory buffers. In some implementations, a trusted execution environment may have paging structures, exception handlers, protected memory regions and hardware resources dedicated or associated with the trusted execution environment. A trusted execution environment is not limited to but may be implemented using one or more trusted execution environments that may include a secure element, SIM/UICC card, or virtualization technology. An exemplary implementation of the trusted execution environment may be a secure element provided on the mobile device.

A “secure element” may include any secure memory device such that the data contained on the secure element cannot easily be hacked, cracked, or obtained by an unauthorized entity. For example, the secure element may be an integrated circuit device that is implemented within a near field communications (NFC) enabled mobile communication device. The secure element may contain embedded smart card-grade applications (e.g., payment, transport, etc.). The secure element may be used by the mobile communication device to host and store data and applications that require a high degree of security. For example, the secure element may be encrypted and may store payment account information, such as account numbers and credentials found in a mobile wallet application or mobile payment application. The secure element may be provided to the mobile communication device by the secure element owner, who may also be the mobile network operator (MNO), original equipment manufacturer (OEM), mobile device manufacturer (MDM), or any other suitable entity. Additionally, the secure element may be either embedded in the handset of the mobile communication device or in a subscriber identity module (SIM) card that may be removable from the mobile communication device. The secure element can also be included in an add-on device such as a micro-Secure Digital (microSD) card or the like.

An “application” may be computer code or other data stored on a computer readable medium (e.g. memory element or secure element) that may be executable by a processor to complete a task. An “applet” can be a simplified application that may be programmed to perform a single or limited specific number of tasks.

A “secure entity application” may be an application providing payment capabilities implemented within a mobile communication device. For example, the secure entity application may be installed in a secure element chip within a near field communications (NFC) enabled portable communication device. The secure entity application may be installed within a designated area of the secure element that may be accessed with a particular secure element key or unique derived key (UDK) provided by the secure element or may be installed in another available area on the secure element. The secure entity application provides the functionality to manage and maintain the consumer's payment information and support mobile payments. During a payment transaction, the secure entity application may interact with an access device of a merchant over a contactless interface to enable a mobile payment transaction. The secure entity application may also support other modes of mobile payments, such as e-commerce, using the mobile communication device. The entity issuing the secure entity application may be an issuer, mobile wallet provider, payment processing network, bank, merchant or other member of the mobile contactless payment system. The secure entity application may also interface with an unsecured application or mobile application provided on a mobile communication device that allows a user to manage the secure entity application, interact with a service provider, or otherwise interface with the contactless payment system.

A “mobile application” may be an application that operates on the mobile communication device. The mobile application may provide a user interface for consumer interaction (e.g., to enter and view information) with the mobile payment application and/or mobile wallet. The mobile application also communicates with the mobile payment application to retrieve and return information during the processing of any of a number of services offered to the consumer via the mobile communication device (e.g., completing a transaction, issuer update processing, etc.). Additionally, the mobile application can communicate with the mobile gateway to send and receive over-the-air (OTA) messages.

As used herein, an “electronic wallet” or “digital wallet” can store user profile information, payment information, bank account information, and/or the like and can be used in a variety of transactions, such as but not limited to eCommerce, social networks, money transfer/personal payments, mobile commerce, proximity payments, gaming, and/or the like for retail purchases, digital goods purchases, utility payments, purchasing games or gaming credits from gaming websites, transferring funds between users, and/or the like.

A “common payment management application (CPMA)” may be an application provided on the secure element of the mobile device. The common payment management application may be accessible by the mobile applications provided on a memory of the mobile device and the secure entity applications provided in the trusted execution environment associated with the mobile device. The common payment management application may facilitate the coordination of account holder verification method s across the mobile applications and the secure entity applications. The common payment management application may verify the user once, and provide the verification results to the mobile applications and the secure entity applications. The common payment management application may pull account holder verification results from the mobile applications and provide the account holder verification results to the secure entity applications automatically or upon request. The secure entity applications may push the account holder verification results to the common payment management application, which may then provide the account holder verification results to the mobile applications.

An “account holder verification method” may be used to evaluate whether the person conducting the transaction is the legitimate account holder. Exemplary account holder verification methods may be performed using account holder verification information such as a user signature, a password, an offline or online plaintext personal identification number (PIN), an offline or online the person conducting the transaction enciphered PIN, a combination of offline plaintext PIN and signature, a combination of offline enciphered PIN and signature, user biometrics, a pattern, a glyph, knowledge-based challenge-responses, hardware tokens (multiple solution options), one time passwords (OTPs) with limited use, software tokens, two-channel authentication processes (e.g., via phone), etc. The online PIN may be electronically sent to and validated by the account issuer. When offline PIN is used as an account holder verification method, instead of sending the PIN to the issuer, the PIN entered by the consumer may be matched to that on the chip card. In some embodiments, the account holder verification method may be a dynamic account holder verification method which includes limited-time passcode, and/or biometric factors such as voice recognition or fingerprint matching.

An “issuer” can include a payment account issuer. During provisioning, issuers (and issuer trusted service managers) may ensure that personalization information is provided to wallet providers to ensure that mobile or digital wallets are properly configured to allow consumer purchases using mobile payment applications on the secure element.

As used herein, a “payment account” (which may be associated with one or more payment devices) may refer to any suitable payment account including a credit card account, a checking account, a savings account, a merchant account assigned to a consumer, or a prepaid account.

I. CPMA Performing Account Holder Verification Method and Sharing Account Holder Verification Results with Applications

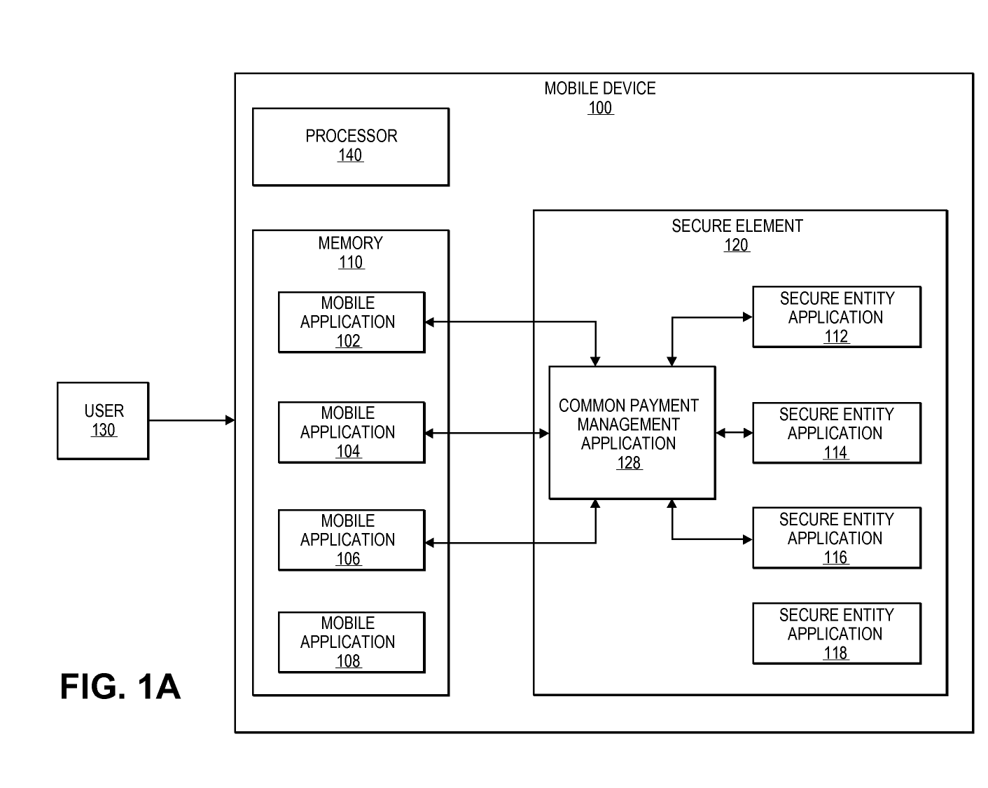

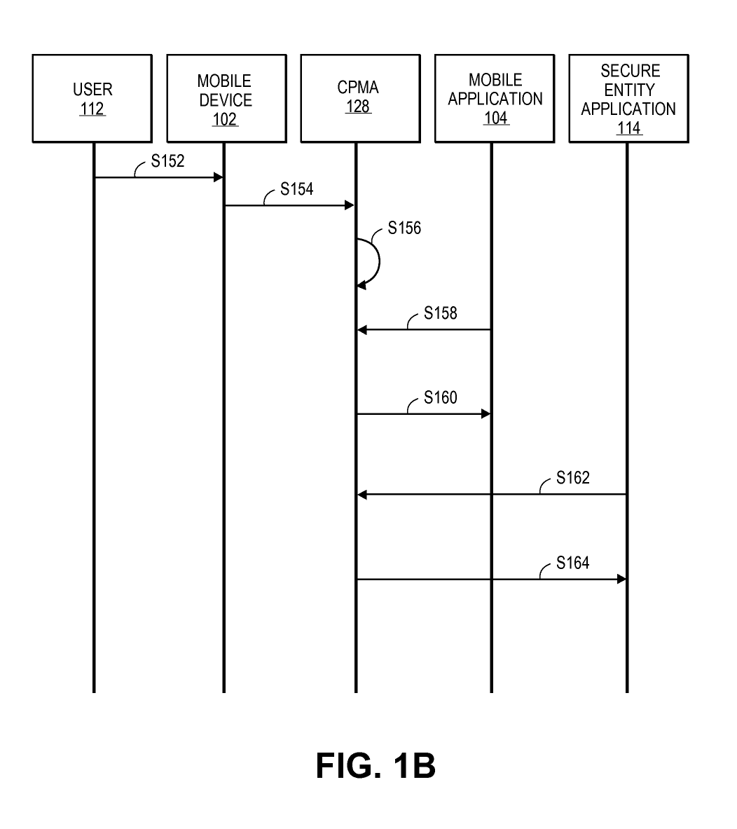

Referring now to FIG. 1A, a block diagram of a user 130 interacting with an exemplary mobile device (also referred to as a portable/mobile communication device) 100 is provided according to embodiments of the present invention.

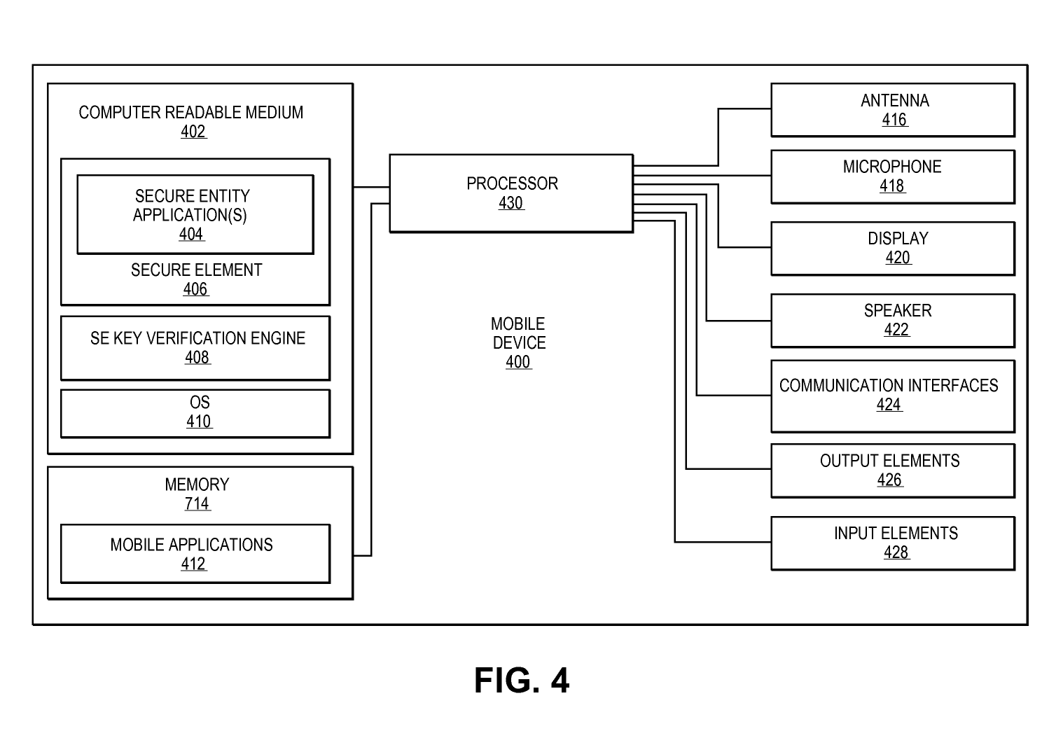

The mobile device 100 may be used to perform mobile banking operations, such as initiating transactions and receiving and displaying transaction alerts, in accordance with some embodiments of the present invention. As used herein, a “mobile device” may include a mobile phone, tablet, netbook, laptop, or any other suitable mobile computing device. Mobile device 100 may include circuitry that is used to enable certain device functions, such as telephony. The functional elements responsible for enabling those functions may include a processor 140 that is programmed to execute instructions that implement the functions and operations of the device. Details of exemplary functional elements of a mobile device are discussed below in greater detail in connection with FIG. 4.

Processor 140 may access memory 110 (or another suitable data storage region or element) to retrieve instructions or data used in executing the instructions. The memory 110 may store information such as financial information, transit information (e.g., as in a subway or train pass), access information (e.g., access badges), serial numbers, mobile account information, and any other suitable information. In general, any of this information may be transmitted by the mobile device 100 (such as to an access device (not shown)), via any suitable method, including the use of antenna or a contactless element.

The memory 110 may store instructions for a wide variety of applications including mobile applications (e.g. wallet applications) 102, 104, 106, 108. The mobile device 100 may have any number of mobile applications installed or stored on the memory 110 and is not limited to those illustrated in FIG. 1A. The mobile applications 102, 104, 106, 108 may be used to initiate, facilitate, and manage transactions using the mobile device 100. The transactions may include contactless transactions, e-commerce transactions, or any other suitable transactions, as one of ordinary skill would recognize.

The mobile applications 102, 104, 106 may be capable of communicating with a wallet provider system (not shown) and may be configured to communicate with a common payment management application 128 provided on a secure element 120 of the mobile device 100. As provided above, the common payment management application 128 is provided in a trusted execution environment associated with the mobile device 100. In the exemplary embodiment illustrated in FIG. 1A, the trusted execution environment is depicted as the secure element 120 of the mobile device 100. One of ordinary skill in the environment will appreciate that the trusted execution environment is not limited to a secure element and may include other environments, such as a secure environment provided on a cloud storage.

The mobile applications 102, 104, 106 may have application programming interfaces (APIs) configured in order to communicate with the common payment management application 128. For example, the mobile applications 102, 104, 106 may communicate with the common payment management application 128 to check whether an account holder verification method was completed. The mobile applications 102, 104, 106 may request and receive the results of the account holder verification method for a user, process, request, etc. from the common payment management application 128 to ensure that the user is validated and verified by the common payment management application 128 to access the mobile applications 102, 104, 106 and/or perform a transaction (or other functionality). Further, in some embodiments, the mobile applications 102, 104, 106 may determine what methods for mobile account holder verification method they want to support. In some embodiments, the mobile applications 102, 104, 106 may be capable of communicating with applications provided on the secure element 120.

The secure element 120 may be coupled to (e.g., embedded within) the mobile device 100 and data or control instructions that are transmitted via a cellular network may be applied to the secure element 120 by means of a secure element interface. The secure element interface functions to permit the exchange of data and/or control instructions between the mobile device circuitry and the secure element 120. The secure element 120 may include a secure memory and a near field communications data transfer element (or another form of short range communications technology). A secure element 120 may typically be implemented in the form of a semiconductor chip (or other data storage element) with an associated wireless transfer (e.g., data transmission) element, such as an antenna.

The secure element enabled mobile device 100 may comprise secure element applications including the common payment management application 128 and a plurality of secure entity applications 112, 114, 116, 118. A secure element 120 or other secure memory on the mobile device 100 may comprise any hardware or software component operable to securely store payment information and any other credentials. The secure element 120 may be accessible by the secure entity applications 112, 114, 116, 118 to generate payment data and dynamic values (e.g., a dynamic cryptogram or dynamic secure card verification values) to ensure an issuer or payment processing network that a transaction originating at the secure entity application is authentic. The mobile device 100 may have any number of secure entity applications installed or stored on the secure element 120 and is not limited to those illustrated in FIG. 1A.

The secure entity applications 112, 114, 116, 118 may comprise any API, service, application, applet, or other executable code suitable to retrieve payment information from a secure element and communicate with an access device to complete a transaction. The secure entity applications 112, 114, 116, 118 may be provisioned onto the secure element 120 by a trusted service manager associated with a mobile network operator, an issuer or other third party. Further, payment networks (e.g., Visa™, American Express™, and Mastercard™) can decide what account holder verification methods to support for a particular wallet or mobile application based on functional or business constraints.

The common payment management application 128 may comprise any instructions, APIs, code, or other software to enable the common payment management application 128 to communicate with the secure entity applications 112, 114, 116 associated with multiple different issuers. The common payment management application 128 may be provisioned onto the secure element 120 at any time either after or during manufacture. Additionally, the secure entity applications 112, 114, 116 and the common payment management application 128 may be personalized at any suitable time with the account holder's specific information.

In some embodiments, a secure entity application 118 provisioned on the secure element 120 or a mobile application 108 provisioned on the memory 110 may not support account holder verification coordination through the common payment management application 128. For example, the secure entity application 118 or the mobile application 108 may not require performing an account holder verification method prior to authorizing a payment transaction. The account holder verification method may not be required for payment transactions for small amounts, e.g. amount smaller than a pre-set value such as $20, or based on commercial terms agreed between the issuer of the payment account and the secure entity application 118 or the mobile application 108. Thus, the secure entity application 118 or the mobile application 108 may not need account holder verification coordination. Alternatively, the secure entity application 118 or the mobile application 108 may simply perform account holder verification method on its own. Accordingly, the secure element 120 may have zero or more secure entity applications provisioned thereon that do not interact with the common payment management application 128. Similarly, the memory 110 may have zero or more mobile applications provisioned thereon that do not interact with the common payment management application 128.

An account holder may be shopping at a merchant or through a communication network to purchase items or services. Accordingly, the account holder may open one of the mobile applications 102, 104, 106, 108 installed on their mobile device 100 to pay for the items or services. Depending on the configuration of the selected mobile applications 102, 104, 106, 108 different modes or methods may be performed in order to complete a transaction while only performing one account holder verification method.

FIG. 1B shows a flow diagram of a method for authenticating the user 130 by the common payment management application 128 and sharing the authentication results with other mobile applications and/or secure entity applications, according to an exemplary embodiment of the present invention. At S152, the user 130 may provide account holder verification information to the mobile device 100. For example, the user 130 may be asked to provide a password, a PIN number, biometrics, draw a pattern, respond to a challenge response authentication test, answer a security question, or may perform any other suitable task to verify and authenticate that they are authorized to use the application. At S154, the information received at the mobile device 100 may be provided to (or passed on to) the common payment management application 128. For example, a user interface associated with the common payment management application 128 may be displayed on a display of mobile device 100, and the user may provide the required information to the common payment management application 128 via the user interface.

At S156, the common payment management application 128 may perform one or more types of account holder verification method to authenticate the user based on the received user input (i.e. the received account holder verification information). The results of the one or more account holder verification methods may be stored at the common payment management application 128.

At S158, one or more of the mobile applications 102, 104, 106 may contact the common payment management application 128 to request the account holder verification results. In some embodiments, the mobile applications may notify the common payment management application 128 of their preferred account holder verification method (or the common payment management application 128 may determine the preferred account holder verification method for each mobile application 102, 104, 106) and the common payment management application 128 may perform the preferred account holder verification method. In some embodiments, the common payment management application 128 may perform any type of account holder verification method that is acceptable by the mobile applications 102, 104, 106. That is, the payment management application 128 may select and perform one or more account holder verification methods unless a specific method is specified by the mobile applications 102, 104, 106. At S160, the common payment management application 128 may return the account holder verification results to the one or more mobile applications 102, 104, 106 in response to the request received from the mobile applications 102, 104, 106 at S158. In some embodiments, the common payment application 128 may return an indicator (e.g. a flag) indicating that an account holder verification method has been performed and that the results of the account holder verification are positive or negative. Accordingly, the mobile application(s) 102, 104, 106 do not need to contact the user 130 to request account holder verification information before performing the account holder verification method for each one of the mobile applications 102, 104, 106.

Similarly, at S162, one or more of the secure entity applications 112, 114, 116 may contact the common payment management application 128 to request the account holder verification results. In some embodiments, the secure entity may notify the common payment management application 128 of their preferred account holder verification method (or the common payment management application 128 may determine the preferred account holder verification method for each secure entity application 112, 114, 116) and the common payment management application 128 may perform the preferred account holder verification method. In some embodiments, the common payment management application 128 may perform any type of account holder verification method that is acceptable by the secure entity applications 112, 114, 116. That is, the payment management application 128 may select and perform one or more account holder verification methods unless a specific method is specified by the secure entity applications 112, 114, 116. At S164, the common payment management application 128 may return the account holder verification results to the one or more mobile applications 102, 104, 106 in response to the request received from the mobile applications 102, 104, 106 at S162. Accordingly, the secure entity applications 112, 114, 116 do not need to contact the user 130 to request account holder verification information before performing the account holder verification method for each one of the secure entity applications 112, 114, 116.

One of ordinary skill in the art will appreciate that steps S158 and S162 of FIG. 1B can occur in any order, and may occur zero or more times. For example, in some embodiments, multiple mobile applications may request account holder verification results from the common payment management application 128 while none of the secure entity applications request the account holder verification results. Alternatively, multiple secure entity applications may request account holder verification results from the common payment management application 128 while none of the mobile applications request the account holder verification results. One of the mobile applications may be invoked multiple times by the user and thus may request the account holder verification results from the common payment management application 128 multiple times, while requesting account holder verification information from the user once.

In some embodiments, the common payment management application 128 may determine the type of account holder verification method required by a mobile application and/or a secure entity application, and perform the determined account holder verification method. The common payment management application 128 may then send the account holder verification results to the mobile application and/or the secure entity application.

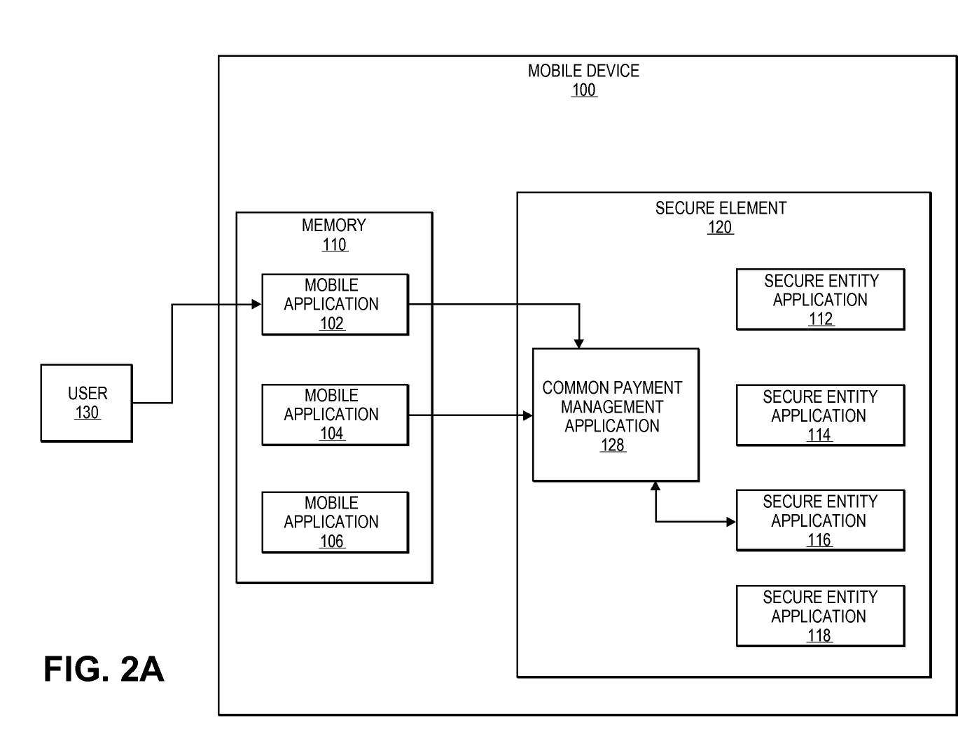

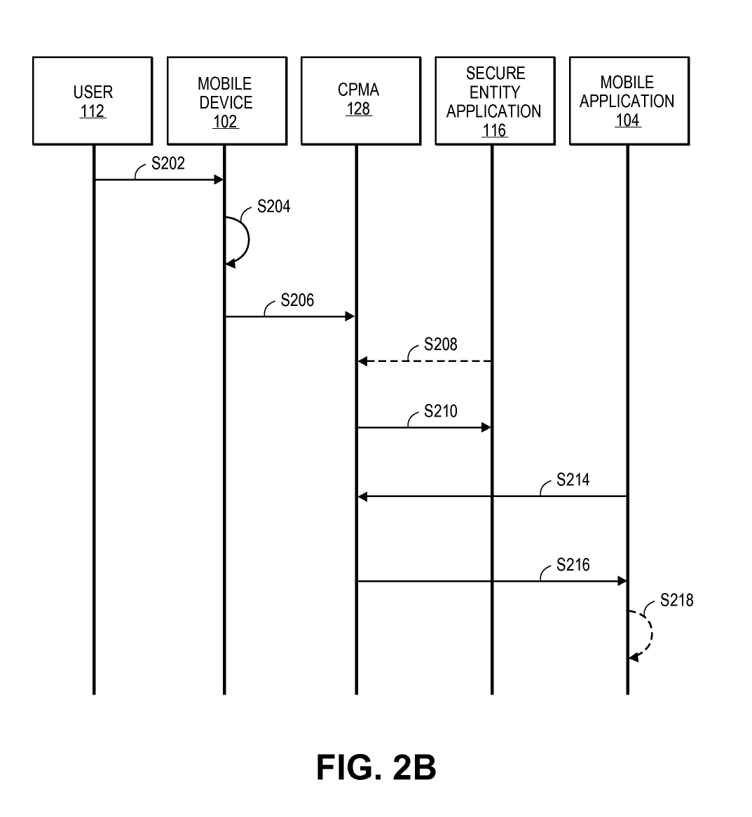

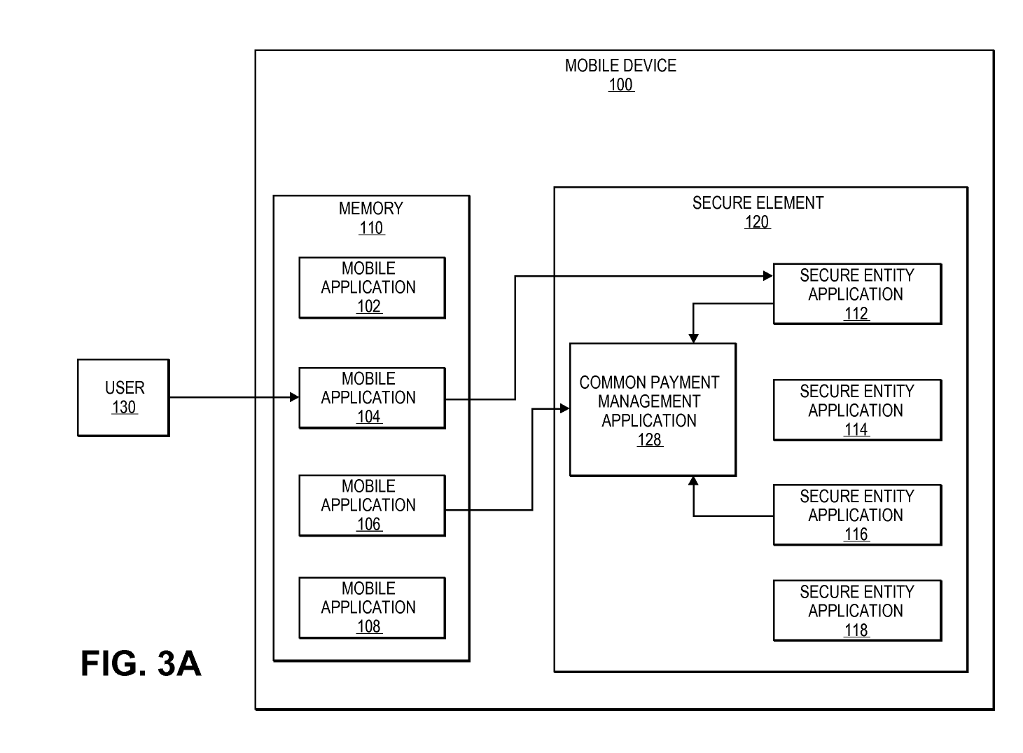

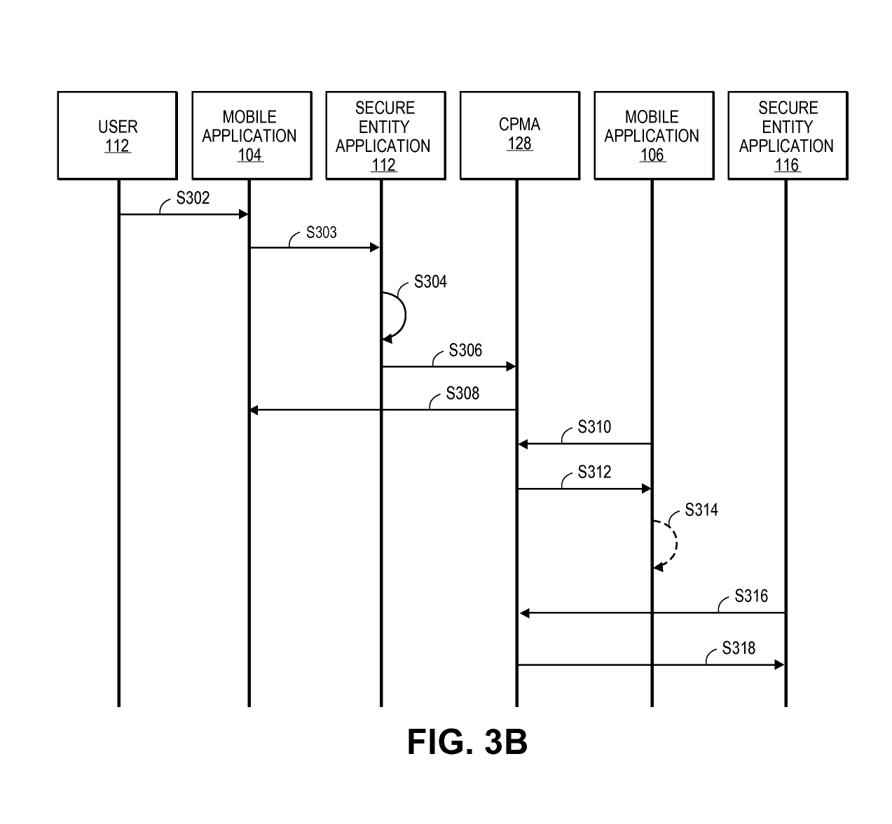

FIGS. 2A-3C illustrate coordinating the results of account holder verification methods performed by an application (i.e. a mobile application or a secure entity application) with other applications (secure entity applications and/or mobile applications) using a common payment management application 128.

II. Account Holder Verification Result Pulled from Mobile Application to CPMA and Shared with Other Applications

According to various embodiments, the result of an account holder verification method performed by a mobile application may be pulled into the common payment management application and provided to a secure entity application (or another mobile application) during a transaction. The mobile application on the mobile device may communicate with common payment management application and provide verification that account holder verification method has been performed. Thereafter, each payment application (mobile application and/or secure entity application) can query the common payment management application on whether the account holder verification result from a mobile application has been acquired. The account holder verification result sharing can occur across secure entity applications and across issuers. Accordingly, a payment application (i.e. another mobile application or a secure entity application) may either receive notice that an account holder verification method has been performed by a mobile application and the account holder verification results provided to the common payment management application. Alternatively, the payment application may query the common payment management application to obtain the account holder verification result during a transaction.

Referring now to FIG. 2A, a block diagram of a user 130 interacting with an exemplary mobile application 102 provisioned on the mobile device 100 is provided according to embodiments of the present invention. The mobile application 102 may be used to initiate, facilitate, and manage transactions using the mobile device 100. The transactions may include contactless transactions, e-commerce transactions, or any other suitable transactions, as one of ordinary skill would recognize.

The mobile application 102 may be capable of communicating with a wallet provider system (not shown) and may be configured to communicate with a common payment management application 128 provided on the secure element 120 of the mobile device 100. The mobile application 102 may have application programming interfaces (APIs) configured in order to communicate with the common payment management application 128. The mobile application 102 may also have a user interface that can be displayed on a screen of the mobile device in order to communicate with the user 130.

When the user 130 accesses (e.g. activates, turns on, runs) the mobile application 102 on the mobile device 100 to conduct a payment transaction, the mobile application 102 may request the user 130 to provide account holder verification information (e.g. passcode, access code, verification code, pattern, biometrics information, etc.). The mobile application 102 may complete an account holder verification information to validate and verify that the user 130 is the authorized account holder who can conduct payment transactions using the mobile application 102. The mobile application 102 may provide the results of the account holder verification method to the common payment management application 128. The common payment management application 128 may store the account holder verification results received from the mobile application 102. The common payment management application 128 may share the account holder verification results with other applications, such as mobile application 104 and/or secure entity application 116 upon request from the mobile application 104 and/or the secure entity application 116.

In some embodiments, the mobile application 102 may be configured to work with one or more secure entity applications, such as the secure entity application 116. The mobile application 102 may notify the common payment management application 128 that the mobile application 102 is configured to work with the secure entity application 116. Alternatively, the common payment management application 128 may determine that the mobile application 102 is configured to work with the secure entity application 116. Accordingly, the common payment management application 128 may send (e.g. broadcast) the account holder verification results directly to the secure entity application 116 without waiting for a request from the secure entity application 116.

The process of sharing the Account holder verification results of a mobile application with other applications will be discussed next in connection with FIG. 2B.

FIG. 2B shows a flow diagram of a method for authenticating the user 130 by the mobile application 102 and sharing the authentication results with other applications through the common payment management application 128. At S202, the user 130 may provide account holder verification information to the mobile application 102. For example, a user interface associated with the mobile application 102 may be displayed on a display of mobile device 100, and the user may provide the required account holder verification information to the mobile application 102 via the user interface. For example, the user 130 may be asked to provide a password, respond to a challenge response authentication test, answer a security question, or may perform any other suitable tasks to verify and authenticate that they are authorized to use the application.

At S204, the mobile application 102 may perform one or more types of account holder verification methods based on the received user input. At S206, the results of the one or more account holder verification methods may be provided to and stored at the common payment management application 128. In some embodiments, the common payment management application 128 may query the mobile application 102 to inquire whether an account holder verification method has been performed and, if the account holder verification method has been performed, may pull the results of the account holder verification method to the common payment management application 128. In other embodiments, the mobile application 102 may send the Account holder verification results to the common payment management application 128 upon performing the account holder verification method. That is, the mobile application 102 may populate the common payment management application 128 with the results of the account holder verification method.

At S208, one or more of the secure entity applications 112, 114, 116 may contact the common payment management application 128 to request the account holder verification results. For example, the user 130 may choose one or more of the secure entity applications 112, 114, 116 to conduct a payment transaction. The selected secure entity applications 112, 114, 116 may query the common payment management application 128 for the account holder verification results. At S210, the common payment management application 128 may return the account holder verification results to the one or more secure entity applications 112, 114, 116 in response to the request received from the one or more secure entity applications 112, 114, 116 at S208. Alternatively, the mobile application 102 may be pre-configured to work with one or more of the secure entity applications 112, 114, 116. The common payment management application 128 may determine that the mobile application 102 is configured to work with the secure entity application 116. At S210, the common payment management application 128 may return the account holder verification results to the secure entity application 116 without waiting for the secure entity application 116 to request the results of the account holder verification method. In some embodiments, the common payment application 128 may return an indicator (e.g. a flag) indicating that an account holder verification method has been performed and that the results of the account holder verification method are positive or negative.

At S214, one or more of the mobile applications 102, 104, 106 may contact the common payment management application 128 to request the account holder verification results. For example, the user 130 may choose one or more of the mobile applications 102, 104, 106 to conduct a payment transaction. Upon user's selection, the selected mobile application may query the common payment management application 128 for the account holder verification results. At S216, the common payment management application 128 may return the account holder verification results to the one or more mobile applications 102, 104, 106 in response to the request received from the mobile applications 102, 104, 106 at S214. In some embodiments, the common payment application 128 may return an indicator (e.g. a flag) indicating that an account holder verification method has been performed and that the results of the account holder verification method are positive or negative.

In some embodiments, at S218, the one or more mobile applications 102, 104, 106 that received the account holder verification results from the common payment management application 128, may either use the account holder verification results directly, or may use the received information to perform their preferred account holder verification method. For example, a mobile application 104 (e.g., a wallet application) may ask the common payment management application 128 whether the user 130 has completed an account holder verification method (e.g., entered the correct passcode) for another payment application (e.g. mobile application 102 or 106, or secure entity application 112, 114, 116). The mobile application 104 could then use this information for its own authentication purposes. Accordingly, the mobile applications 102, 104, 106 do not need to contact the user 130 to request account holder verification information before performing the account holder verification method for each one of the mobile applications 102, 104, 106.

One of ordinary skill in the art will appreciate that steps S208 and S214 of FIG. 2B can occur in any order, and may occur zero or more times. For example, in some embodiments, multiple mobile applications may request account holder verification results from the common payment management application 128 while none of the secure entity applications request the account holder verification results. Alternatively, multiple secure entity applications may request account holder verification results from the common payment management application 128 while none of the mobile applications request the account holder verification results. One of the mobile applications may be invoked multiple times by the user and thus may request the account holder verification results from the common payment management application 128 multiple times, while requesting account holder verification information from the user once.

III. Account Holder Verification Result Pushed from Secure Entity Application to CPMA and Shared with Other Applications

According to various embodiments, the result of an account holder verification method performed by a secure entity application may be pushed into the common payment management application and provided to a mobile application (or another secure entity application) during a transaction. The secure entity application on the mobile device may communicate with common payment management application and provide verification that account holder verification method has occurred. Thereafter, each payment application (mobile application and/or secure entity application) can query the common payment management application on whether the account holder verification result from another application has been acquired or not. The account holder verification result sharing can occur across secure entity applications and across issuers. Accordingly, a payment application (i.e. another secure entity application or a mobile application) may either receive notice that an account holder verification method has been performed by a secure entity application and account holder verification results (or an indication thereof such a flag) provided to the common payment management application, or the payment application may query the common payment management application to obtain the account holder verification method result during a transaction.

Referring now to FIG. 3A, a block diagram of a user 130 interacting with an exemplary mobile application 104 provisioned on the mobile device 100 is provided according to embodiments of the present invention. The mobile application 104 may be used to initiate, facilitate, and manage transactions using the mobile device 100. The transactions may include contactless transactions, e-commerce transactions, or any other suitable transactions, as one of ordinary skill would recognize.

When the user 130 accesses (e.g. activates, turns on, runs) the mobile application 104 on the mobile device 100 to conduct a payment transaction, the mobile application 104 may request the user 130 to provide account holder verification information (e.g. passcode, access code, verification code, biometrics information, pattern, PIN, etc.). The mobile application 104 may be configured to work with the secure entity application 112. Accordingly, the mobile application 104 may pass the received account holder verification information directly to the secure entity application 112.

The secure entity application 112 may be capable of communicating with a wallet provider system (not shown) and may be configured to communicate with a common payment management application 128 provided on the secure element 120 of the mobile device 100. The secure entity application 112 may have application programming interfaces (APIs) configured in order to communicate with the common payment management application 128.

The secure entity application 112 may complete an account holder verification method to validate and verify that the user 130 is the authorized account holder who can conduct payment transactions using the secure entity applications 112. The secure entity application 112 may provide the results of the account holder verification method to the common payment management application 128. The common payment management application 128 may store the account holder verification results received from the secure entity application 112. The common payment management application 128 may share the account holder verification results with other applications, such as mobile application 106 and/or secure entity application 116 upon request from the mobile application 104 and/or the secure entity application 116.

The process of sharing the account holder verification results of a secure entity application with other applications will be discussed next in connection with FIG. 3B.

FIG. 3B shows a flow diagram of a method for authenticating the user 130 by the secure entity application 112 and sharing the authentication results with other mobile applications through the common payment management application 128. At S302, the user 130 may provide account holder verification information to a mobile application 104. For example, the user 130 may be asked to provide a password, respond to a challenge response authentication test, answer a security question, or may perform any other suitable task to verify and authenticate that they are authorized to use the application. The mobile application 104 may be pre-configured to work with the secure entity application 112. Accordingly, at S303, the mobile application 104 may transmit the received user input (i.e. account holder verification information provided by the user) directly to the secure entity application 112.

At S304, the secure entity application 112 may perform one or more types of account holder verification method based on the received user input. At S306, the results of the one or more account holder verification methods may be provided to (e.g. pushed to) and stored at the common payment management application 128. In some embodiments, the common payment management application 128 may query the secure entity application 112 to inquire whether an account holder verification method has been performed and, if the account holder verification method has been performed, may request the results of the account holder verification method to be sent to the common payment management application 128. In other embodiments, the secure entity application 112 may push the account holder verification results to the common payment management application 128 upon performing the account holder verification method.

The common payment management application 128 may determine that the secure entity application 112 works with the mobile application 104. In some embodiments, the mobile application 104 or the secure entity application 112 may notify the common payment management application 128 that the mobile application 104 and the secure entity application 112 work in pair. Thus, at S308, the common payment management application 128 may provide the account holder verification results received from the secure entity application 112 to the mobile application 104.

At S310, one or more of mobile applications 102, 104, 106 may contact the common payment management application 128 to request the account holder verification results. For example, the user 130 may choose one or more of the mobile applications 102, 104, 106 to conduct a payment transaction. Upon user's selection, the selected mobile application may query the common payment management application 128 for the account holder verification results. At S312, the common payment management application 128 may return the account holder verification results to the one or more mobile applications 102, 104, 106 in response to the request received at S310.

The one or more mobile applications 102, 104, 106 that received the account holder verification results from the common payment management application 128, may use the account holder verification results directly. Alternatively, in some embodiments, the one or more mobile applications 102, 104, 106 may use the received information to perform their preferred account holder verification method (at optional step S314). For example, a mobile application 106 (e.g., a wallet application) may ask the common payment management application 128 whether an account holder verification method has been performed for another payment application (e.g. mobile application 102 or 104, or secure entity application 112, 114, 116). The mobile application 106 could then use this information for its own authentication purposes. Accordingly, the mobile applications 102, 104, 106 do not need to contact the user 130 to request account holder verification information before performing the account holder verification method for each one of the mobile applications 102, 104, 106.

Similarly, at S316, one or more of the secure entity applications 112, 114, 116 may contact the common payment management application 128 to request the account holder verification results. At S318, the common payment management application 128 may return the account holder verification results to the one or more secure entity applications 112, 114, 116 in response to the request received at S314.

One of ordinary skill in the art will appreciate that steps S310 and S316 of FIG. 3B can occur in any order, and may occur zero or more times. For example, in some embodiments, multiple mobile applications may request account holder verification results from the common payment management application 128 while none of the secure entity applications request the Account holder verification results. Alternatively, multiple secure entity applications may request account holder verification results from the common payment management application 128 while none of the mobile applications request the account holder verification results. One of the mobile applications may be invoked multiple times by the user and thus may request the account holder verification results from the common payment management application 128 multiple times.

### IV. Technical Advantages and Other Specifications

According to various embodiments, the account holder may open a payment application that is provisioned onto a mobile device and the common payment management application provides verification to the payment application that an account holder verification method has been performed and the result of the account holder verification method was positive. In some embodiments, the common payment management application could also provide any other information related to a transaction (e.g., payment information, tokens, or any information that may be useful during a transaction) to the payment application. Alternatively, in some embodiments, the common payment management application may ping or otherwise send the account holder verification results directly to a selected payment application if the common payment management application knows which payment application has been selected for a transaction.

The above process of a payment application (either a mobile application or a secure entity application) requesting an account holder verification result from the common payment management application could be repeated such that a first application and a second application could request account holder verification results from the common payment management application and both applications could obtain verification of the verification results without requesting an account holder verification information from the account holder directly. Further, the first application and the second application could be configured to complete two different account holder verification methods and the common payment management application can provide sufficient verification for both.

The common payment management application may comprise any API, service, application, applet, or other executable code suitable to perform the functionality described herein. The common payment management application may have an internal API that works with any issuer, wallet provider, or any other application to coordinate account holder verification methods among the mobile applications located on the general purpose memory and the secure entity applications located in the trusted execution environment associated with the mobile device. To prevent unauthorized manipulation of account holder verification method support or account holder verification results, the common payment management application may be configured to communicate with registered mobile applets/applications only. Further, the common payment management application may be either created by or specified by the wallet provider. The common payment management application may determine which account holder verification methods are valid for which secure entity application or mobile application.

As noted, a mobile phone or similar device is an example of a portable communication device that may be used to display alerts as described with reference to embodiments of the present invention. However, other forms or types of devices may be used without departing from the underlying concepts of the invention. Further, devices that are used to display alerts may not require the capability to communicate using a cellular network in order to be suitable for use with embodiments of the present invention. Additionally, as would be appreciated by one of ordinary skill in the art, the mobile device described above may have only some of the components described below, or may have additional components.

### V. Exemplary Mobile Communication Device

Referring now to FIG. 4, a functional block diagram of a mobile communication device (also referred as “mobile device”) 400 according to an embodiment of the present invention is illustrated.

The mobile device 400 may comprise components to both be the interrogator device (e.g. receiving data) and the interrogated device (e.g. sending data). Thus, the mobile device 400 may be capable of communicating and transferring data or control instructions via both cellular network (or any other suitable wireless network—e.g. the Internet or other data network) and short range communications (e.g., using near-field communication (NFC) communications protocols).

As shown in FIG. 4, the mobile communication device 100 may be in the form of cellular phone, having a display 420 and input elements 428 to allow a user to input information into the device 400 (e.g., keyboard) and/or the memory 414. The mobile communication device 400 can also include a processor 430 (e.g., a microprocessor) for processing the functions of the mobile communication device 400, at least one antenna 416 for wireless data transfer, a microphone 418 to allow the user to transmit his/her voice through the mobile communication device 400, and speaker 422 to allow the user to hear voice communication, music, etc. In addition, the mobile communication device 400 may include one or more interfaces in addition to antenna 416, e.g., a wireless interface coupled to an antenna. The communications interfaces 424 can provide a near-field communication interface (e.g., contactless interface, Bluetooth, optical interface, etc.) and/or wireless communications interfaces capable of communicating through a cellular network, such as GSM, or through WiFi, such as with a wireless local area network (WLAN). Accordingly, the mobile communication device 400 may be capable of transmitting and receiving information wirelessly through both short range, radio frequency (RF) and cellular and WiFi connections.

Additionally, the mobile communication device 400 can be capable of communicating with a global positioning system (GPS) in order to determine to location of the mobile communication device. In the embodiment shown in FIG. 4, antenna 416 may comprise a cellular antenna (e.g., for sending and receiving cellular voice and data communication, such as through a network such as a 3G or 4G network), and interfaces 424 may comprise one or more local communication. In other embodiments contemplated herein, communication with the mobile communication device 400 may be conducted with a single antenna configured for multiple purposes (e.g., cellular, transactions, etc.), or with further interfaces (e.g., 3, 4, or more separate interfaces).

The mobile communication device 400 can also include a computer readable medium 402 coupled to the processor 430, which stores application programs and other computer code instructions for operating the device, such as an operating system (OS) 410. In an embodiment of the present invention, the computer readable medium 402 can include a secure entity application 404. The secure entity application 404 can be accessed only when a secure element 406 of the computer readable medium 402 is accessed, such as through communication with a trusted service manager. In addition, the application can include a customizable user interface (UI), which can be determined by the user's preferences through application level programming. These preferences can be securely communicated through the antenna 416 to an issuer of the account stored in the secure entity application 404. The secure entity application 404 can be used to securely complete contactless payments through account stored on the mobile communication device 400 and/or in a mobile wallet associated with the user of the mobile communication device 400.

Referring again to FIG. 4, the secure element (SE) 406 can be an encrypted memory element of the computer readable medium 402. The secure element 402 can be accessed through a Secure Element Key Verification Engine 408, which can also be located in the computer readable medium 402. The Secure Element Key Verification Engine 408 can receive keys from contactless communication, e.g., antenna 416 and either grant or deny access to the secure element 406.

The computer readable medium 402 on the mobile communication device 400 can also include additional mobile applications 412, which can be downloaded to the memory 414 by a user of the mobile communication device 400. The mobile communication device 400 can additionally include an integrated camera , capable of capturing images and/or video. In certain embodiments, the memory 414 may include a non-transitory computer readable storage medium for storing data saved on the mobile communication device 400.

The above description is illustrative and is not restrictive. Many variations of the invention may become apparent to those skilled in the art upon review of the disclosure. The scope of the invention may, therefore, be determined not with reference to the above description, but instead may be determined with reference to the pending claims along with their full scope or equivalents.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

One or more features from any embodiment may be combined with one or more features of any other embodiment without departing from the scope of the invention.

A recitation of “a”, “an” or “the” is intended to mean “one or more” unless specifically indicated to the contrary.

What is claimed is:

1. A method comprising:
receiving, at a management application located in a trusted execution environment associated with a mobile device, an account holder verification information;
receiving, at the management application, a first account holder verification request from a first application;
providing a first account holder verification response to the first application, wherein the first account holder verification response is generated by the management application using the account holder verification information;
receiving, at the management application, a second account holder verification request from a second application; and
providing a second account holder verification response to the second application, wherein the second account holder verification response is generated by the management application using the account holder verification information.

2. The method of claim 1, wherein the account holder verification information is an account holder verification result generated by a third application.

3. The method of claim 1, further comprising:
authenticating, by the management application, a user associated with an account on the mobile device using the account holder verification information, the authenticating generating an authentication result,
wherein the first account holder verification response and the second account holder verification response comprise the authentication result.

4. The method of claim 1, wherein the account holder verification information comprises one or more of a user name, a password, a personal identification number (PIN), an account number, a pattern and biometrics information.

5. The method of claim 1, wherein the first application or the second application is provided in the trusted execution environment associated with the mobile device.

6. The method of claim 1, wherein the first application or the second application is provided on a memory of the mobile device separate from the trusted execution environment.

7. The method of claim 1, further comprising:
registering, with the management application, the first application or the second application.

8. The method of claim 1, wherein the first application and the second application require two different account holder verification methods.

9. The method of claim 1, further comprising:
determining, by the management application, that a first account holder verification method is required by the first application;
generating, by the management application, the first account holder verification response based on the first account holder verification method; and
generating, by the management application, the second account holder verification response based on one or more second account holder verification methods.

10. The method of claim 9, wherein the one or more second account holder verification methods are selected by the management application.

11. A method comprising:
receiving, at a management application located in a trusted execution environment associated with a mobile device, an account holder verification result generated by a first application based on the first application verifying an identity of an account holder;
determining, by the management application, that the first application is configured to work with a second application to conduct a payment transaction, wherein the first application and the second application are provided on one or more memory locations on the mobile device; and
automatically providing, by the management application, the account holder verification result to the second application, wherein the second application processes the payment transaction sing the account holder verification result.

12. A server computer comprising:
a processor; and
a non-transitory computer readable medium coupled to the processor, the computer readable medium comprising code, that when executed by the processor, causes the processor to:
receive, at a management application located in a trusted execution environment associated with a mobile device, an account holder verification information;
receive, at the management application, a first account holder verification request from a first application;
provide a first account holder verification response to the first application, wherein the first account holder verification response is generated by the management application using the account holder verification information;
receive, at the management application, a second account holder verification request from a second application; and
provide a second account holder verification response to the second application, wherein the second account holder verification response is generated by the management application using the account holder verification information.

13. The system of claim 12, wherein the account holder verification information is an account holder verification result generated by a third application.

14. The system of claim 12, wherein the code, when executed by the processor, further causes the processor to:
authenticate, by the management application, a user associated with an account on the mobile device using the account holder verification information, the authenticating generating an authentication result,
wherein the first account holder verification response and the second account holder verification response comprise the authentication result.

15. The system of claim 12, the account holder verification information comprises one or more of a user name, a password, a personal identification number (PIN), an account number, a pattern and biometrics information.

16. The system of claim 12, wherein the first application or the second application is provided in the trusted execution environment associated with the mobile device.

17. The system of claim 12, wherein the first application or the second application is provided on a memory of the mobile device separate from the trusted execution environment.

18. The system of claim 12, wherein the code, when executed by the processor, further causes the processor to:
register, with the management application, the first application or the second application.

19. The system of claim 12, wherein the first application and the second application require two different account holder verification methods.

20. The system of claim 12, wherein the code, when executed by the processor, further causes the processor to:
determine, by the management application, that a first account holder verification method is required by the first application;
generate, by the management application, the first account holder verification response based on the first account holder verification method; and
generate, by the management application, the second account holder verification response based on one or more second account holder verification methods.

21. The system of claim 20, wherein the one or more second account holder verification methods are selected by the management application.

22. A method comprising:
receiving, by a first application provided on a mobile device, a payment request for a transaction conducted using the mobile device;
sending, by the first application, an account holder verification request to a management application located in a trusted execution environment associated with the mobile device;
receiving, at the first application, an account holder verification response from the management application, wherein the first account holder verification response is generated by the management application using account holder verification information provided to the management application by a user or a second application on the mobile device; and
processing the payment request for the transaction based on the account holder verification response.
